(19) United States
(12) Patent Application Publication
(10) Pub. No.: US 2004/0117218 A1
(43) Pub. Date: Jun. 17, 2004

(54) Method and device for providing conferences

(76) Inventors: Peter Friedrich, Petershagen (DE); Norbert Lobig, Darmstadt (DE)

Correspondence Address: MORRISON & FOERSTER LLP, 1650 TYSONS BOULEVARD, SUITE 300, MCLEAN, VA, 22102, US

(21) Appl. No.: 10/644,090

(22) Filed: Aug. 20, 2003

(30) Foreign Application Priority Data
Aug. 21, 2002 (DE) 10238287.5

(51) Int. Cl. G06F 17/60

(52) U.S. Cl. 705/5

(57) ABSTRACT

A control interface is provided between an announcement/dialog function with voice recognition functionality and a conference management function. The conference can be booked and controlled via this interface. In this case, the conference management function receives the data relevant to the conference in a dialog with the conferees, reserves the relevant resources in advance and access the control functions of the conference directly via a further interface.

### CLAIM FOR PRIORITY

This application claims priority to German application 10238287.5, which was filed in the German language on Aug. 21, 2002, the contents of which are hereby incorporated by reference.

### TECHNICAL FIELD OF THE INVENTION

The invention relates to a method and a device for providing conferences, and in particular, a control interface provided between an announcement/dialog function with voice recognition functionality and a conference management function.

### BACKGROUND OF THE INVENTION

In the prior art, services for audio conferences are part of the indispensable range of services provided by voice switching networks. They are implemented by the exchanges (switching centers) of the network or also by network elements external to the exchanges. In these cases the conference function is based on a mixing function for the audio stream of the conference participants (conferees), said function being provided by a special piece of hardware with DSP (Digital Signal Processor) capacity.

Conventionally, where the user information channel of a connection is routed into the exchange, the conference functions and announcement and tone functions required for this can be provided by peripheral devices equipped with the appropriate functionality or by external devices. However, if the user data is routed outside of the exchange in a packet network, then at least one external conference system is preferably used for this. This external conference system has interfaces to the packet network for the user data of the conference. Here, the user data of the conference is either the user data of the individual conferees or the announcements/dialogs and tones to be incorporated as well as the mixed signal generated via at least one conference bridge and to be distributed to the conferees. The external conference system can additionally have a control interface to the exchange which is active for controlling connections routed outside of the exchange in the packet network. This controls the desired basic functions during the conference or initiates the distribution of announcements/dialogs and tones generated, for example, in the external conference system.

Basically, conference services comprise a plurality of conference service features, these being distinguished and demarcated with regard to initiation and control of the course of the conference:

Thus, on the one hand there are conference service features by means of which users are included as conferees in the conference by DIAL-IN (conferee dials in to the conference) or by DIAL-OUT (conferee calls from within the conference), i.e. the course taken by the conference is characterized by the availability of the conferees (e.g. by users being connected to the conference or by users exiting the conference).

On the other hand, there are conference service features which are characterized by the conference leader or the conferees of the controlled conferences. In this case, for example, a conference leader can make use of suitable DSS1 signaling (ETSI ADD-ON conference) or an additional graphical means of control at a PC-like terminal device to connect conferees, mute them or disconnect them from the conference. These conference service features for controlling the conference are frequently available to the conference service operator, who can manage the conference resources in the network and monitor the conference service.

With regard to video conferences, which are used increasingly in packet-based networks, the control requirement of the conference is increased by the participating conferees, who to an increasing extent would like to able to influence the image to be seen. This includes selection of one or more conferees during the conference, a voice-activated means of switching over the image to the conferee who is currently speaking, simultaneous image availability of a certain number of conferees, as well as the additional insertion and display of documents.

In the reverse direction, the existing conference solutions notify the conferees currently participating in a conference of the entry of a further conferee into the conference or of the fact that a conferee has left the conference by means of conference tones and/or by means of a generally small number of conference announcements of appropriate content.

With regard to initiation and control of the conferences, conference services are differentiated as follows:

With the ETSI ADD-ON conference, operation and control are by definition only possible in a local exchange. It is initiated and controlled (digit sequence operation) via subscriber signaling. It can be implemented primarily in TDM networks—but also in packet-based networks with exchanges that support traditional subscriber signaling, and can be initiated immediately on demand (AD HOC).

The PRESET conference represents a compromise based on AD HOC initiation with simultaneously predefined conferees list.

The PHONEMEET conference is offered as a general service in the network (public conference). This service, very similar to the chat service on the Internet although much older, provides a service code under which users can dial into a conference dealing with a specific topic and exchange views with conferees who have already dialed in to discuss that topic. The conferees generally do not know one another and also have no guarantee that they will be connected to a new common conference if they dial in again. The characterizing feature of this service is that users who generally do not know one another can engage in conversation in the public network. In this case no control by conferees is necessary, and an automatic troublemaker monitoring function is also not available. Some network providers allow the availability of the conference and the undisturbed course of the conference to be monitored by operators who are responsible for detecting and isolating disagreeable troublemakers by periodic listening-in.

Pre-reserved conferences are available as DIAL-IN, DIAL-OUT or MIXED DIAL-IN/DIAL-OUT conferences. They can be used in particular for business customers. A disadvantage is that pre-reservation and conference planning must be completed manually, which means an AD HOC availability is not provided.

For the sake of completeness, mention should also be made of conference services with a Web-based user interface (such as Siemens SURPASS WEBCONFER, for example) and TERMINAL conferences which are supported in accordance with certain signaling standards. The former can be reserved and controlled via Internet accesses. The advantage of Web-based control with status display is limited by the disadvantage of Internet access with a possibly additionally required terminal device for the conference leader as well as a lack of interactions with the conferees. TERMINAL conferences are conferences for audio, video, data which are possible, for example, using the specifications of the H.323 standard (or also SIP standards) and are based on the functions of the terminal devices, which means that traditional terminal devices cannot be used. In this case a central bridge can be dispensed with. However, it means that large conferences with many conferees are not possible due to the limited performance of the terminal devices. A further disadvantage is the increased bandwidth requirement between the conferees.

Resources must be provided in the network for all conference services. Since conference resources mean a cost-intensive investment for the network provider, they are not held in reserve in unlimited quantities in the network. This means an increased control overhead, for in addition to the interactions of the conference leader and the conferees during the conference there is also generally a poll taken to agree on the conference date, coordination of the availability of the conferees and appropriate conference resources as well as notification of the participants on time and access authorization in order to ensure the success of a conference.

Experience has shown that the conferences which can be initiated on an AD HOC basis have a user interface characterized by the digit sequence control used in telephony or a graphical user interface tied to a higher-quality, intelligent, possibly additional terminal device, the interface setting limits to the random instant controllability from any terminal device. The system tones and announcements made available to the conferees permit only global conclusions to be drawn about the progress and status of the conference. With regard to the pre-reserved conferences, considerable manual interactions may be required before the start of the conference under certain circumstances. Such obstacles inhibit the use, handling and success of conference solutions.

### SUMMARY OF THE INVENTION

The invention relates to conference services such that their operation and control are considerably simplified.

One advantage of the invention is that a control interface is provided between an announcement/dialog function with appropriate voice recognition functionality and a conference management function. This considerably simplifies the preparation and operation/control of conference services. For example, the conference-controlling functional inputs via digit strings can be dispensed with, since the techniques based on voice recognition functionality support a more convenient dialog between human being and machine. Corrections of inputs by conferees or operator are therefore easily possible. Basically, this simplifies operation and control for all currently known conference types in TDM and packet-based network environments, i.e. in particular for DIAL-IN, DIAL-OUT, MIXED DIAL-IN/OUT, ETSI ADD-ON, PHONEMEET with/without operator monitoring, PRESET conference.

Furthermore, the conference functionality of AD HOC-initiated conferences in particular is decoupled from the subscriber signaling and is available at the remote level (i.e. more generally in further switching systems of, for example, competing network providers). Add-on devices with graphical user interface are not required. Similarly, the involvement of the operator with regard to the monitoring, reservation and/or procedural organization of conferences is minimized.

Another advantage of the invention is the positive effects on the conference services. For example, the availability of the ETSI ADD-ON conference functionality with easy controllability is provided not only in the local exchange, but also in any TDM or packet-based network through the use of techniques based on (DTMF) voice recognition for overcoming the restrictions of subscriber signaling. Techniques based on voice recognition are advantageously used whenever compressing coding methods which do not guarantee interference-free DTMF transmission are used, particularly in packet-based networks. Furthermore, reservation and administration processes for conference services can be automated through the use of appropriate IVR (Interactive Voice Response) logic in exactly the same way as troublemaker detection and monitoring initiation as well as control of follow-up activities by means of voice recognition mechanisms. Finally, simultaneous control of conference functionality is possible by means of (DTMF) voice inputs by conference leader and conferees in a conference that is in progress. This enables IVR dialogs to be passed on to individual or all conferees for detailed status outputs in an ongoing conference. Basically, this concept enables combined ADD-ON, MEET-ME and PRESET conferences to be implemented and provided with additional service features.

### BRIEF DESCRIPTION OF THE DRAWINGS

The invention is explained in more detail below with reference to exemplary embodiments illustrated in the drawings, in which:

FIG. 1 shows basic relationships in the network.

FIG. 2 shows network elements and interfaces integrated for reservation of a conference.

### DETAILED DESCRIPTION OF THE INVENTION

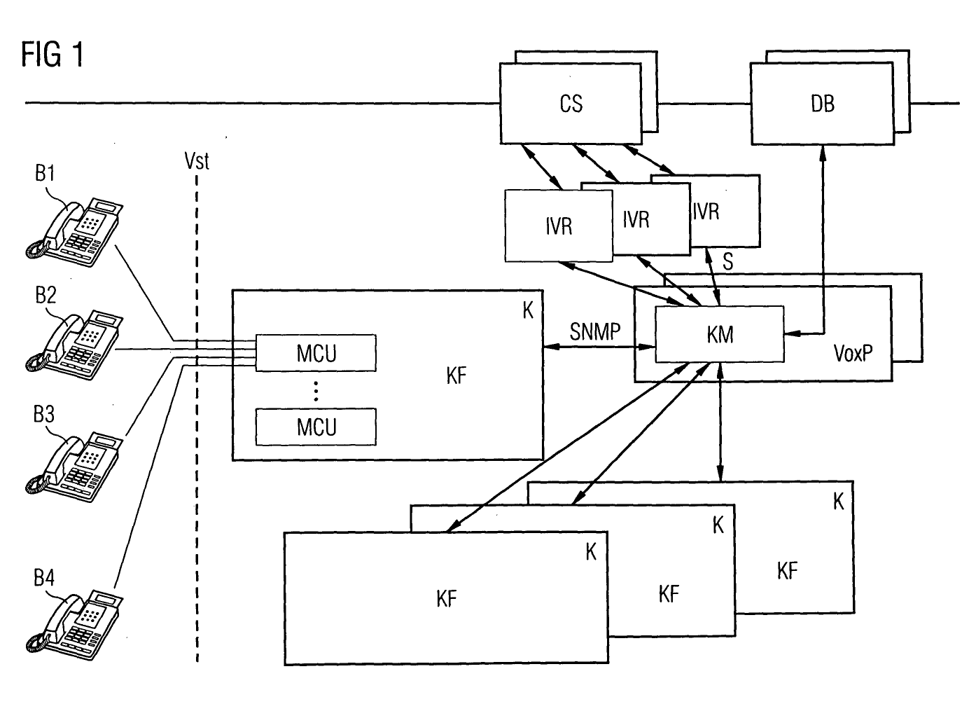

The basic relationships according to the invention are shown in FIG. 1. According to one exemplary embodiment, it is assumed that a public TDM or packet-based, particularly IP-based, network, is present in which at least one announcement and dialog function IVR, one conference management function KM and at least one conference function KF are present in each case for providing convenient conference services.

FIG. 1 also shows by way of example four subscribers B1 through B4 who would like to attend a conference. These four conferees are served and controlled by a switching system Vst. Also disclosed in FIG. 1 are a number of mutually independent conference systems K in which the conference function KF is executed. Interface devices MCU should be considered as part of a conference system and be regarded as the termination of the user data streams from and to the conferees.

The user data of the conferees is switched through under the control of the exchange Vst and routed to these interface devices MCU. This is also where the mixing of user data streams takes place.

The conference function-KF essentially constitutes a classical mixing function of multiple input signals for audio or video signals. Furthermore it supports the distribution function also for further information. The platform to be provided for this is characterized by telephony interfaces for adapting to network and signaling as well as by DSP-based mixing functions for the audio stream and where applicable further functions for controlling the video outputs (e.g. voice-activated video switching).

The conference function KF supports conference service features such as DIAL-IN or DIAL-OUT in conference connections whose descriptive data is provided to a conference management function KM via a control interface. By means of this interface, the conference management function can intervene at any time in the configuration of a conference in progress and take control. The SNMP protocol, for example, is used as the protocol between conference management function KM and the conference systems.

There are conferees who are characterized such that their input user data stream is picked up before being mixed with the conference mixing signal and passed to an announcement and dialog function IVR for a certain time for the purpose of monitoring for disruptive activities or for detecting legitimate conference-controlling inputs (e.g. by the conference leader). In this case, the feature of permanent or temporary connection of an announcement and dialog function IVR can be applied via a control interface S between announcement and dialog function IVR and conference management function KM.

The announcement and dialog function IVR is executed on at least one separate device or where appropriate also collocated with the function KM—which is explained in more detail below—on a device VoxP. It serves for controlling the dialog with the input recognition by the conference leader or the conferees, wherein DTMF inputs, menu-driven dialogs or preferably keyword recognition in natural dialog (natural dialogue, keyword spotting) come into consideration. Because of the performance required in public networks, the hardware platform required for the announcement and dialog function IVR is generally characterized by telephony interfaces which handle the adaptation to the network technology and signaling, as well as by hardware and software which handle the voice recognition tasks (e.g. DSPs, voice recognition algorithms).

The conference-specific dialog flows required for the announcement and dialog function IVR are suitably stored on a content server CS, e.g. in the form of VoiceXML scripts which are written on the basis of the conference configuration and produce the complete dialog sequence for the IVR system.

Finally, FIG. 1 shows a conference management function KM which is implemented as a software function and which is executed on a device VoxP. This handles the general, where applicable network-wide, monitoring and management of the status of the conference systems K and their ports. Another functionality lies in the reservation of the pre-reserved conferences, in the timely activation and monitoring/control of the conferences themselves, as well as in the generation of charge tickets, particularly with regard to the reservation of resources in the network. The conference management function KM stores reservation data and charging data and if necessary trouble indicators as well as traffic and statistical data on a database server DB.

According to the invention, the announcement and dialog function IVR has a control interface S for the conference management function KM by means of which it can output reservation data of a conference or the initial conference parameters of an AD HOC conference to the conference management function for further handling. In the reverse direction, the announcement and dialog function IVR may obtain information about the resource requirements that can be catered for either currently or for the intended reservation period from the conference management function and also where applicable charge information for designing the dialog with the party ordering the conference/conference leader.

The conference management function monitors the availability of conference resources, on a network-wide scale where necessary, and can therefore also support and reserve in particular conferences which, because of their size or in the event of resource bottlenecks, extend across a number of conference systems (cascading).

Finally, database server DB, content server CS, conference management function KM, announcement and dialog function IVR, and the conference function KF are configured at least in duplicate for reasons of fault tolerance. The functions mentioned do not necessarily have to be implemented on different hardware platforms. IVR function and KM function in particular can be implemented on different hardware platforms.

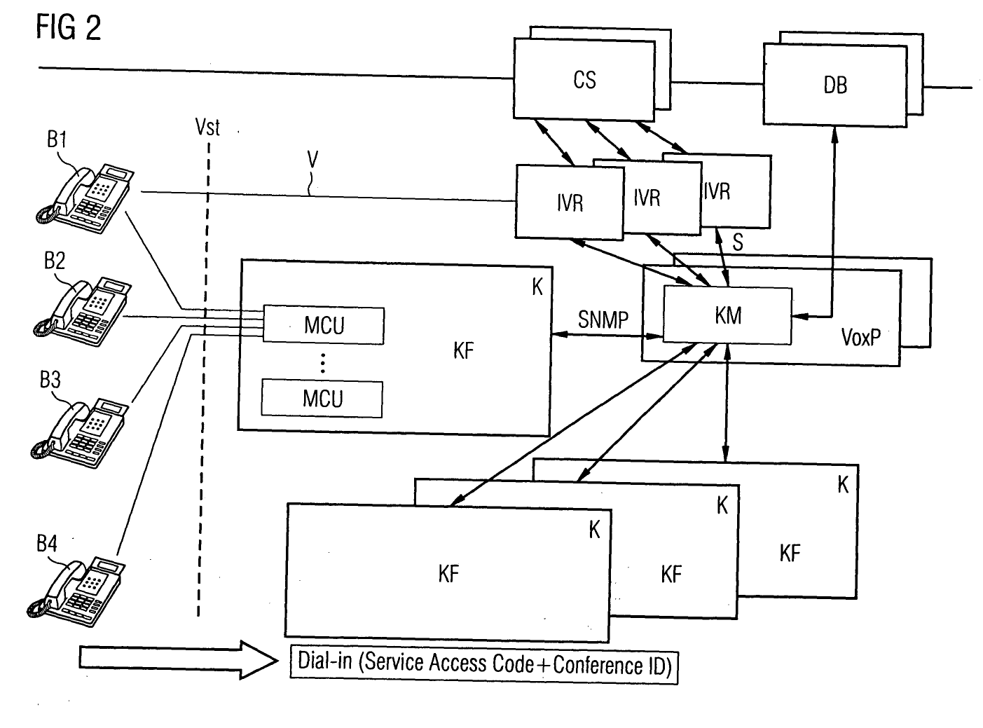

Reservation of conferences is illustrated in FIG. 2 as an application of the method according to the invention. Accordingly, a plurality of conference systems K is available in the packet-based network. Each of these conference systems K provides a certain number of conference ports for audio or video conferences. The conference systems K represent autonomous network elements which are not controlled by the exchanges Vst in the network. Conference connections are therefore seen by the exchanges Vst of the network as a plurality of through-connections to or from an extension or a plurality of extensions of the network.

The conference service is handled independently by the conference systems K. According to the reservation that has been made, the participants in a conference are called at the desired time or the conference is made available to the conferees so they can dial in during the desired time interval. Conference tones or conference announcements are independently set up or mixed for the conferees by the conference systems K. For this purpose, use can be made of the aforementioned IVR functions or of conference system integrated announcement and tone functions.

In practice, the reservation of the conference can take place via a plurality of servers. The latter have an overview of the network-wide availability of the conference resources via a possibly duplicated and therefore fault-tolerant database. If necessary, the data associated with the reserved conferences is also stored in the database in order to safeguard it against loss due to failure situations. After an appropriate operator dialog has taken place in which the key data of the desired conference (i.e. typically the number of conferees, start time, duration, call numbers of the conferees to be called, and features of the conference (audio, video, bandwidth) and features of the conferees (conferees with and without talk authorization)) has been made known, the conference resources are reserved in the database. At the same time the conference management function KM of the conference is activated to ensure that the participating conference systems K are supplied with the data of the conference at the desired time and activate the conference (i.e. release resources for DIAL-IN or initiate DIAL-OUT in accordance with conferees list).

The reservation of the conference is effected by calling a service number, whereupon an automatic voice dialog of the reservation system with the caller develops in order to determine the conference data. In the simplest case, this dialog can of course be controlled by DTMF and proceed in menu-like fashion with or without voice recognition. Preferably, however, the dialog is keyword-controlled by means of suitable voice recognition mechanisms and in this way permits the caller to proceed with the reservation in impromptu fashion in a dialog which is conducted via a connection V between announcement and dialog system IVR and the reserving caller.

As an example, the reservation could be conducted in a natural dialog as follows:

Machine: Hello and welcome to Deutsche Telekom's DIAL-IN conference service. What can we do for you?

Caller: I would like to book a conference with five participants for tomorrow.

Machine: Your conference is to take place tomorrow, on Mar. 28, 2002, and is to include a maximum of five participants. Please give the desired start time and duration.

Caller: It should start at 9:30 am and I estimate that we will need a maximum of ¾ of an hour. But now I come to think of it, probably only four participants will be necessary.

Machine: So you would like to reserve a conference with a maximum of four participants for a maximum duration of 45 minutes for tomorrow, Mar. 28, 2002, at 9:30 am?

Caller: Yes, exactly!

Machine: Would you like to order a video conference?

Caller: Unfortunately we only have very old terminal devices.

Machine: Conference resources for an audio conference with up to four participants will be ready for you tomorrow, that is on Mar. 28, 2002, from 9:30 am 10:15 am. The charge is EUR 102.43. We will charge this amount to your telephone bill. Do you now wish to book the conference?

Caller: Okay, but it's very expensive!

Machine: The conference is booked for you. The DIAL-IN number which you should please notify to your conferees is 089/722-24895 346. The costs will be charged to your telephone number 089/830930 and amount to EUR 102.43. We will happily accept chargeable changes to your order with reference to the DIAL-IN number up to 15 minutes before the start of the conference. With regard to the rates for the conference service, we draw your attention to our off-peak rates which apply between 23:30 and 3:30. Do you have any further requests?

Caller: No

Machine: Thank you for calling and Happy Easter.

The flow of the dialog is preferably designed centrally in retrievable form as a VoiceXML page. The aforementioned servers have the announcement and dialog function IVR and where necessary additionally integrated conference management functions KM. In particular, they handle the IVR dialog with the caller booking the conference and provide the capacity for processing the user inputs.

The division of functions illustrated results in many new service features. For example, the ordering party or the DIAL-OUT conferees can be notified in failure situations that their conference has not been set up. Reminder calls/dialogs or other types of messages via FAX or e-mail are also possible before the start of the conference. The administration of PRESET conferences is made possible with incorporation of the conference resources. Assignment and fixing rates of priorities with associated dialog are possible in a customer-friendly manner even in resource shortage situations.

In the case of a PRESET conference, a dialog for producing and modifying a conference list replaces the conference reservation dialog. Instead of the conference identification being output, the activation dial-in of the prepared or modified conference list is output. In the simplest case the activation is effected by dialing into the IVR system, whereupon the IVR system initiates the conference management function KM of the PRESET conference immediately in accordance with the conference list stored in the database. Since the PRESET conference is initiated on an AD HOC basis, there is a possibility of unpredictable resource bottlenecks, which the IVR system can notify to the subscriber initiating the PRESET conference and automatically discuss remedial action, e.g. reducing the size of the conference list for the pending PRESET activation. Similarly, the continuation of the conference, where necessary with a reduced number of participants, after the reserved time has expired can be offered provided the conference resources in the network allow this.

What is claimed is:

1. A method for booking conferences having at least one dialog function and at least one conference function, comprising:
providing a conference management function to control the at least one conference function; and
booking the conference by means of a call to a service number by a conferee, such that with support of the conference management function, an automatic dialog between an announcement/dialog function and a caller develops to determine key data of a desired conference and of the conferees, wherein
a reservation of conference resources is supported by the conference management function in accordance with the key data, such that timely initiation of the conference is ensured.

2. The method according to claim 1, wherein activation of the conference is controlled by the conference management function such that participating conference systems are supplied with the conference data at a desired time.

3. The method according to claim 1, wherein the dialog between announcement/dialog function and the conferees is DTMF-controlled.

4. The method according to claim 1, wherein the announcement/dialog function is provided with a keyword-controlled voice recognition function, such that the dialog between announcement/dialog function and the conferees is voice-controlled.

5. The method according to claim 1, wherein the key data of the conference is defined by number, start time, duration, and call numbers of the conferees and by features of the conference with regard to audio, video, or bandwidth.

6. The method according to claim 1, wherein the key data of the conferees is defined with regard to talk authorization.

7. The method according to claim 1, wherein the conference management function knows the availability of conference function and announcement/dialog function on a network-wide scale, handles reservations and stores the information securely against loss.

8. The method according to claim 1, wherein the conference management function, the announcement/dialog function and the conference function are implemented at least in duplicate on at least two different hardware platforms.

9. The method according to claim 1, wherein the conference management function intervenes at any time in the control of a conference and activates the announcement/dialog function to provide information to and poll the conferees.

10. A device for reserving conferences, having at least one dialog function and at least one conference function which is executed on at least one conference system, comprising a control interface provided between the announcement/dialog function and a conference management function, via which interface the conference management function receives booking data to initiate and control at least one conference, reaches agreement with an ordering party following verification of resources, and confirms the booking to the ordering party.
